(19) United States
(12) Patent Application Publication
(10) Pub. No.: US 2006/0178774 A1
(43) Pub. Date: Aug. 10, 2006

(54) Sortation platforms with in-bulk identification and continuous tracking of items

(76) Inventor: Dan Reznik, Plainsboro, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/348,186

(22) Filed: Feb. 6, 2006

Related U.S. Application Data
(60) Provisional application No. 60/651,789, filed on Feb. 10, 2005.

(51) Int. Cl. G06F 7/00; B07C 9/00; B65G 47/46

(52) U.S. Cl. 700/224; 209/651; 209/583; 198/370.02

(57) ABSTRACT

A system and method for package sortation are provided, where package identification and sortation occur simultaneously on the same package manipulation area, and identification and continuous tracking of items are performed on a bulk stream, the system including an input conveyor, at least one lateral motion device disposed relative to the input conveyor, and at least one extraction zone disposed relative to the lateral motion devices; and the method including receiving bulk items, identifying the bulk items, conveying the bulk items, tracking the bulk items, and sorting the bulk items while they are still in bulk by means of a manipulation array under algorithmic control.

### CROSS-REFERENCE TO RELATED APPLICATION

This application claims the benefit of U.S. Provisional Application Ser. No. 60/651,789 (Attorney Docket No. 2005P02469US), filed Feb. 10, 2005 and entitled “Sortation Platforms Based on In-Bulk Identification and Continuous Tracking of Items”, which is incorporated herein by reference in its entirety.

### BACKGROUND

In materials handling applications, the sorter is typically the last stage of a singulated item pipeline. Prior to sortation, parcels must be identified one by one, such as when they flow single file through a portal, by their bar codes or radio frequency identification (RFID), for example. Sorting typically refers to diverting packages with known identities to desired exit chutes.

One drawback of this technology is the size of sorter platforms; to be sure, a large and often passive singulator bed is required, followed by a very long sorter subsection. Another drawback is the relative brittleness of the system with respect to load variability, where choke points of the sortation system can get quickly overwhelmed by sudden increases in load, with lack of programmability of package selection and gapping parameters.

Recently, a more compact, programmable singulator technology, based on a distributed array of conveyor belts and computer-vision-based parcel tracking, has been provided. Examples are described in co-pending U.S. Patent Application Publication No. 20030141165 (Attorney Docket US2004P10087). This platform possesses the qualities of smaller footprint and flexible programmability, such as inter-parcel gaps, number of exits, and the like.

It is desirable to extend the capabilities of this technology to allow it to combine a vision-based package tracking means with simultaneous, in-bulk, identification of packages, such as by placing directional RFID antennas and/or bar code beams above the package flow. In this way, a machine might singulate and pre-sort or sort on the same manipulation bed.

### SUMMARY

The present disclosure extends manipulation platforms with vision based singulation, in-bulk location, identification, and sortation, by presenting manipulation means which can achieve a variety of industry specific parcel manipulation functions.

An exemplary sortation system for in-bulk identification and continuous tracking of items includes an input conveyor, a lateral motion device disposed relative to the input conveyor, and an extraction zone disposed relative to the lateral motion device.

An exemplary sortation method for in-bulk identification and continuous tracking of items includes receiving bulk items, identifying the bulk items, conveying the bulk items, tracking the bulk items, and sorting the bulk items while they are still in bulk.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a system and method for sortation with in-bulk identification and continuous tracking of items in accordance with the following exemplary figures, in which:

FIG. 1 shows a schematic diagram of a system for sortation with in-bulk identification and continuous tracking of items in accordance with an illustrative embodiment of the present disclosure;

FIG. 2 shows a flow diagram of a method for sortation with in-bulk identification and continuous tracking of items in accordance with an illustrative embodiment of the present disclosure;

FIG. 3 shows a schematic diagram of a translational sortation system with in-bulk identification and continuous tracking of items in accordance with an illustrative embodiment of the present disclosure;

FIG. 4 shows a schematic diagram of another translational sortation system with in-bulk identification and continuous tracking of items in accordance with an illustrative embodiment of the present disclosure;

FIG. 5 shows a schematic diagram of another translational sortation system with in-bulk identification and continuous tracking of items in accordance with an illustrative embodiment of the present disclosure;

FIG. 6 shows a schematic diagram of yet another translational sortation system with in-bulk identification and continuous tracking of items in accordance with an illustrative embodiment of the present disclosure;

FIG. 7 shows a schematic diagram of a rotational sortation system with in-bulk identification and continuous tracking of items in accordance with an illustrative embodiment of the present disclosure;

FIG. 8 shows a schematic diagram of another rotational sortation system with in-bulk identification and continuous tracking of items in accordance with an illustrative embodiment of the present disclosure;

FIG. 9 shows a schematic diagram of another rotational sortation system with in-bulk identification and continuous tracking of items in accordance with an illustrative embodiment of the present disclosure; and

FIG. 10 shows a schematic diagram of yet another rotational sortation system with in-bulk identification and continuous tracking of items in accordance with an illustrative embodiment of the present disclosure.

### DETAILED DESCRIPTION OF PREFERRED EMBODIMENTS

The present disclosure provides a sorter apparatus in which location, identification, and tracking of items may all occur while the items are still in the bulk flow. In the present disclosure, the means of manipulation and its flow-transforming capability, which may be tailored to the application, may be based on a combination of straight or curved conveyors, a manipulation array, and a cross-belt slat conveyor for individual item extraction. The manipulation machinery is under algorithmic control, where the algorithms may be customized for each application and machine geometry.

A series of exemplary applications is presented where a bulk-fed stream of items such as parcels, crates, consumer articles, returns, or the like, is spatially manipulated to achieve a specific operation such as sortation, separation, order consolidation, palletizing, depalletizing, parallel presentation, rejection, reordering, or the like. These applications may use a sensor, distributed manipulation and a control algorithm on a system for early, in-bulk identification of parcels. The criteria for identification may include item shape, color, barcode, radio frequency identification (RFID) tags, or the like. Advantages of the presently disclosed generic platform include a dramatic reduction in footprint, such as one twentieth the size of conventional systems, reduction of equipment by combined functionality, function programmability such as parcel gaps, delivery location and orientation, number of exit points, and compatibility with heterogeneous induct and takeaway machinery.

In exemplary embodiments of the present disclosure, a criterion for early identification can be based on shape, color, weight or any means that allows for high-probability item classification. Extensive use is made of cross-belt slat conveyor technology as the means for selective extraction from bulk. Flexible control algorithms are used, which are mindful of machine geometry and application. Vision-based tracking may be used, which can extend completely or partially over a machine. Vision-based or antenna based identification technologies may also be used.

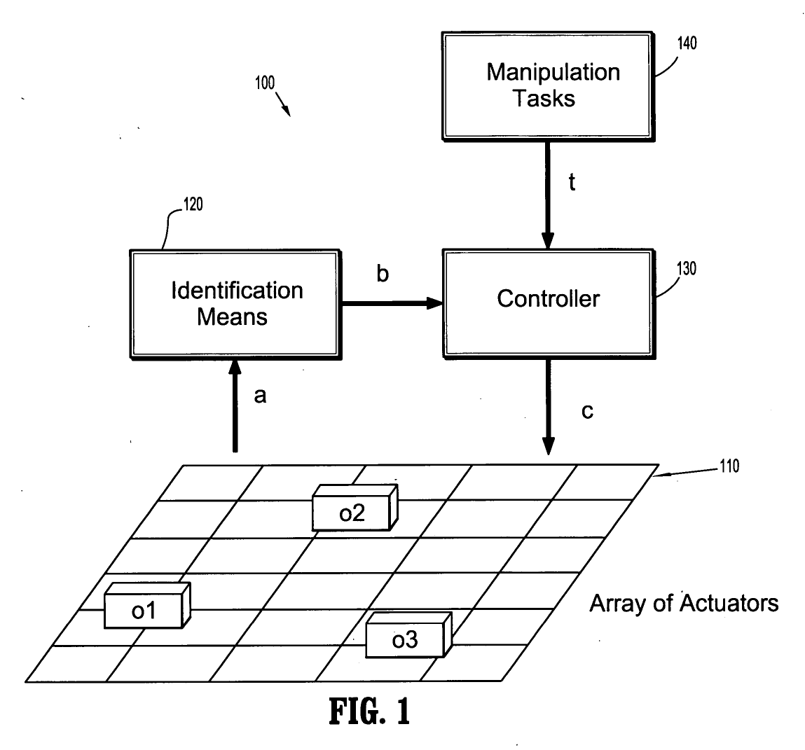

As shown in FIG. 1, a sortation system for in-bulk identification and continuous tracking of items, according to an illustrative embodiment of the present disclosure, is indicated generally by the reference numeral 100. The system 100 includes an array of actuators 110, an identification unit 120 in signal communication with the array, and a controller 130 in signal communication between the identification unit and the array. The system 100 further includes a manipulation unit 140 in signal communication with the controller. In operation of the system 100, the manipulation unit 140 transmits to the controller 130 a high-level manipulation task “t”, such as to “sort packages, singulate packages, palletize packages”, for example. The controller, in turn, uses “t” and sensory data “b” received from the identification unit 120 to compute actuator settings “c”, sent to the manipulation array 110, on which a plurality of packages, objects, items and/or loads rests. For example, objects o1, o2 and o3 may rest on the array 110. The identification unit 120 produces sensory data “b” in parametric form, such as a list of package locations and orientations, by an identification and localization algorithm. The identification and localization algorithm takes as input sensory data “a” in the proximity of the manipulation array, such as computer vision, binary photo eyes, radio frequency identification (RFID), or the like. The identification unit 120 functions to report to a control algorithm of the control unit 130 the appropriate position and identification of a plurality of loads currently on the manipulation bed or array. The controller 130, in turn, utilizes this data to compute actuator settings, such as speeds, diverting commands and the like, which achieve the task at hand “t”.

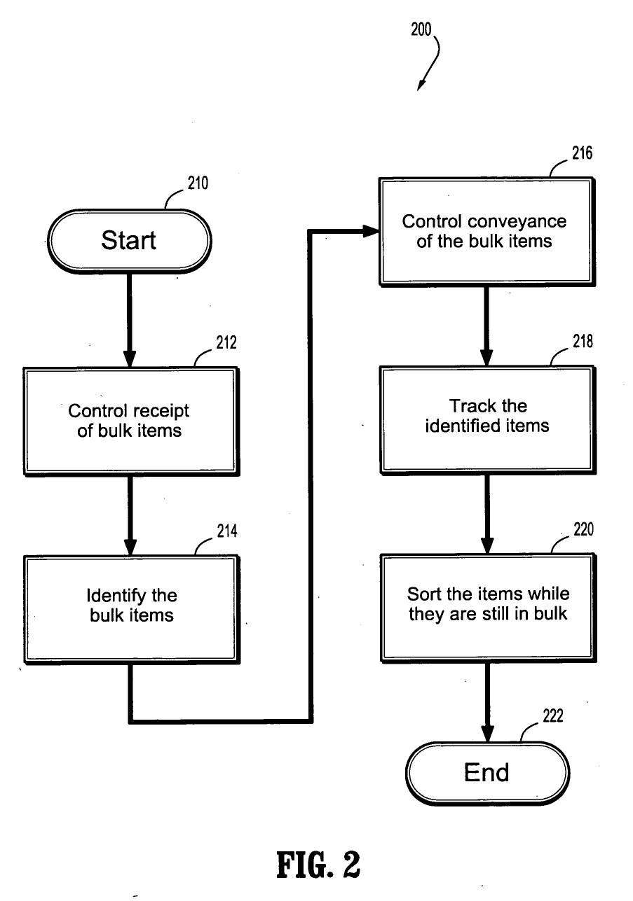

Turning now to FIG. 2, a method for sortation with in-bulk identification and continuous tracking of items is indicated generally by the reference numeral 200. A start block 210 passes control to a receiving block 212. The receiving block 212 controls receipt of bulk items, and passes control to an identification block 214. The identification block 214 identifies the bulk items, and passes control to a conveying block 216. The conveying block, in turn, controls conveyance of the bulk items, and passes control to a tracking block 218. The tracking block 218 tracks the identified items, and passes control to a sorting block 220. The sorting block 220, in turn, sorts the items while they are still in bulk, and passes control to an end block 222.

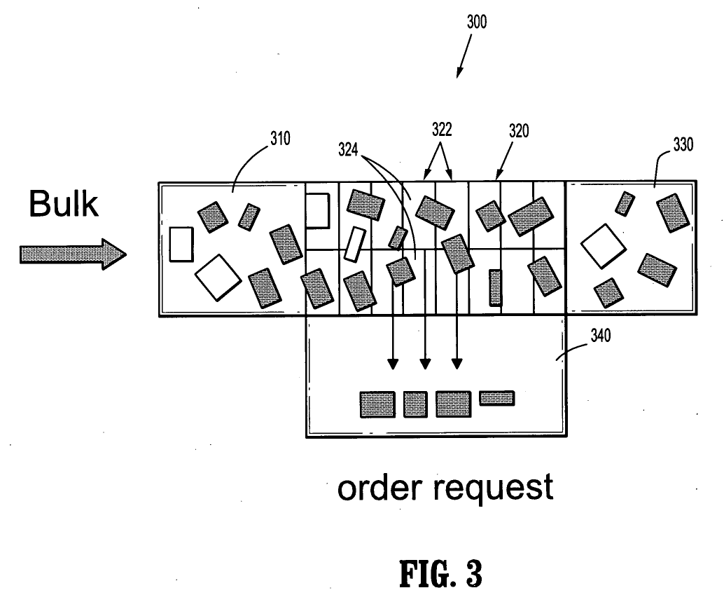

Turning now to FIG. 3, an exemplary embodiment manipulation system relating to in-bulk order consolidation, which is extracting a required set of items as they flow in bulk, is indicated generally by the reference numeral 300. The manipulation system (MS) 300 includes an input bulk conveyor 310, a lateral extractor (LE) 320, an optional overflow bidirectional conveyor 330 downstream from the LE, and an extraction zone 340.

The LE 320 includes one or more cross-conveyor sections 322 with principal motion along the bulk flow. Each section includes a plurality of perpendicular (cross) belts 324, with selective bidirectional speed. The LE 320 allows for unobstructed parcels to be selectively extracted from the bulk flow so as to fulfill an order. The constituents of the bulk flow can be chosen so as to match an expected order request distribution and therefore reduce the average order consolidation time.

To allow for perpendicular item extraction, the control algorithm ensures that the lineal spacing between items is sufficient to achieve collision-free extraction. Thus, a bulk flow enters the lateral extractor (LE) 320 and specific items are extracted from the flow to fulfill an order. The control algorithm ensures that items in the flow are sufficiently spaced to allow extraction by the LE 320.

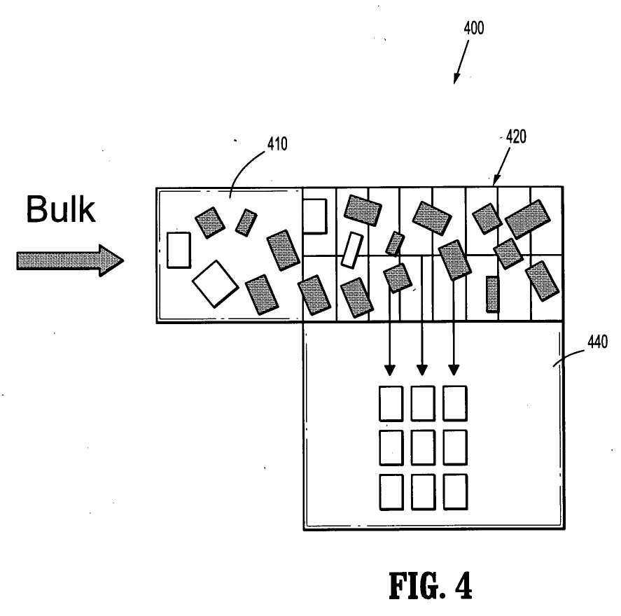

As shown in FIG. 4, another exemplary embodiment manipulation system (MS) is indicated generally by the reference numeral 400. The system 400 is similar to the system 300 of FIG. 3, but lacks the optional overflow bidirectional conveyor 330 of FIG. 3. The system 400 includes an input bulk conveyor 410, a lateral extractor (LE) 420, and an extraction zone 440.

The LE 420, as well as the other downstream and/or upstream manipulation sections, is used to extract objects belonging to a desired group, while aligning them and grouping them densely so as to form a pallet. Palletizing may be based on object identity, and can be used to palletize any objects currently circulating. Note that because the LE is a sideways array manipulator, it can use differential speeds for alignment and relative motion of items. Thus, the MS 400 combines selective extraction with the alignment capabilities of the cross-belt area to extract desired parcels into pallets.

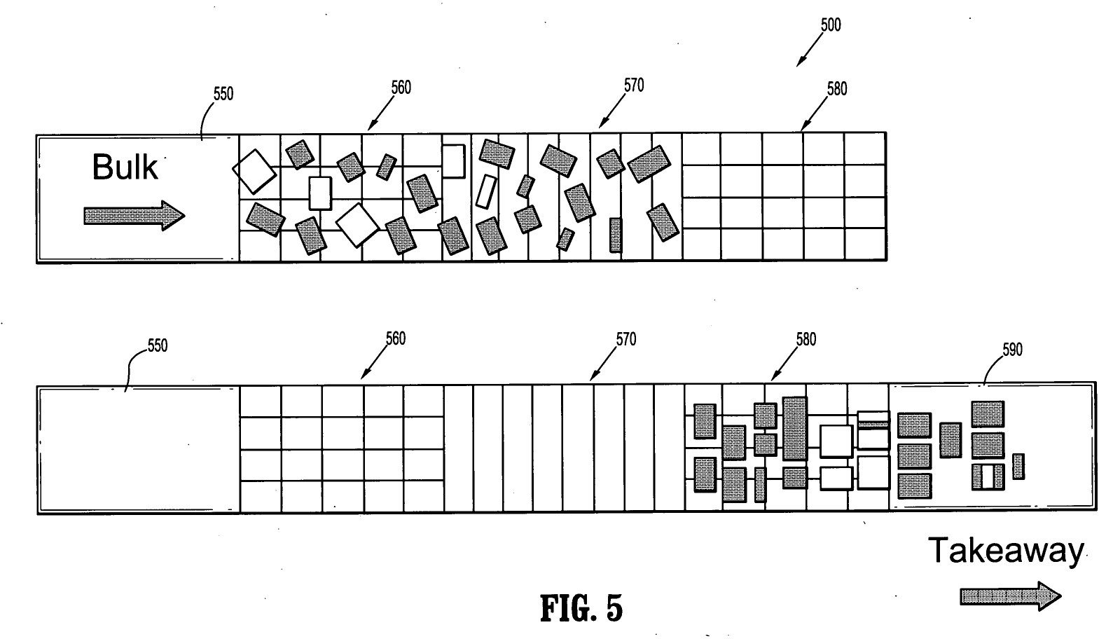

Turning to FIG. 5, another an exemplary embodiment manipulation system (MS) is indicated generally by the reference numeral 500. The system 500 includes a lateral manipulator (LM) 570 that is preceded by a manipulator array (MA) 560, consisting of an array of conveyor belts directed along the bulk flow, and with individually controllable speeds. The MA 560 receives bulk from an input bulk conveyor 550.

Optionally, the LM 570 is followed by a secondary MA 580 for additional manipulation and/or temporary storage. The MA's principal function is to produce required lineal displacements between parcels so they can be extracted and/or further manipulated by the LM 570. An MA plus LM plus optional MA structure also applies for the previous embodiments, and can be used for speeding up order consolidation, palletizing, and other operations. In addition, the MS 500 may include an extraction zone 590 following the secondary MA 580.

The exemplary system embodiment 500 is shown as an “in order” delivery platform, whereby the bulk flow is lineally and laterally displaced so as to organize it for delivery in accordance to known item identities. Flow motion includes bidirectional flow along the MAs and the LM, lineal relative motion on the MAs, and lateral relative motion on the LM.

Thus, in the MS 500, parcels fed in bulk are reordered and (optionally) realigned to deliver similar groups in order. The lateral manipulation area is skirted by an upstream manipulation array for lineal manipulation, and optionally by a downstream one.

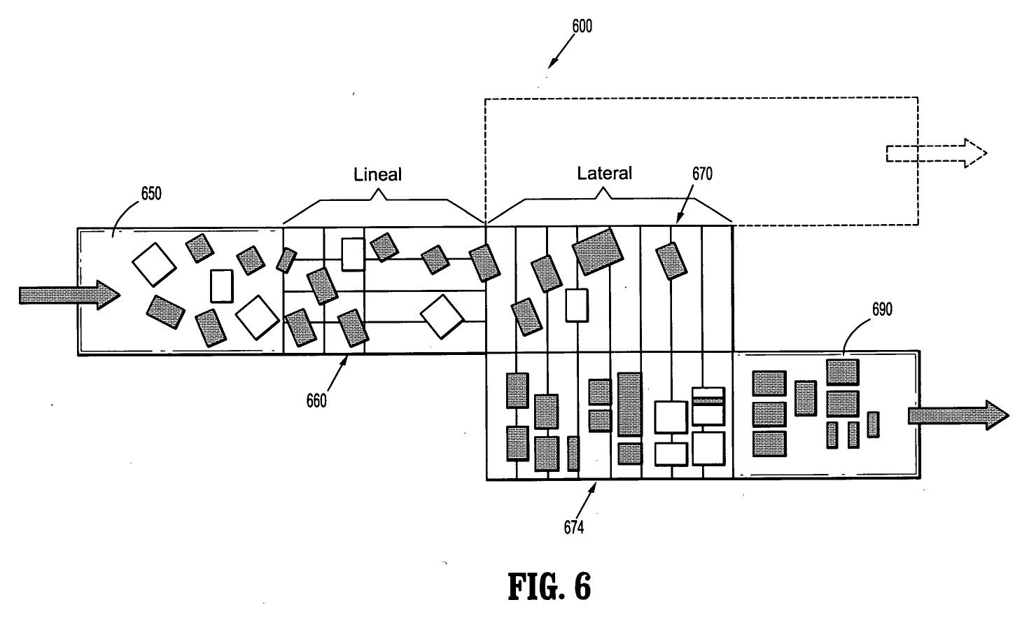

Turning now to FIG. 6, another an exemplary embodiment manipulation system (MS) is indicated generally by the reference numeral 600. The MS 600 is a variant of the previous embodiment 500 of FIG. 5. The system 600 includes a first lateral manipulator (LM) 670 that is preceded by a manipulator array (MA) 660, consisting of an array of conveyor belts directed along the bulk flow, and with individually controllable speeds. The MA 660 receives bulk from an input bulk conveyor 650. A second lateral manipulator (LM) 674 is disposed laterally from the LM 670, and is followed by an extraction zone 690. Optionally, a third lateral manipulator (LM) may be disposed laterally from the LM 670 on a side opposite to that of the second LM 674, and be followed by a second extraction zone.

Thus, the MS 600 includes an LM 670 and/or 674 that is a wider and possibly a multiple section device. In-order and possibly palletized item delivery occurs at a portion of the device positioned adjacent to the main bulk flow. For symmetry and increased rates, two such delivery portions, such as one on the left and one on the right, can coexist. This is similar to the previous embodiment 500 of FIG. 5, except that one or two in-order extraction zones are positioned to the left or right of the lateral manipulation area.

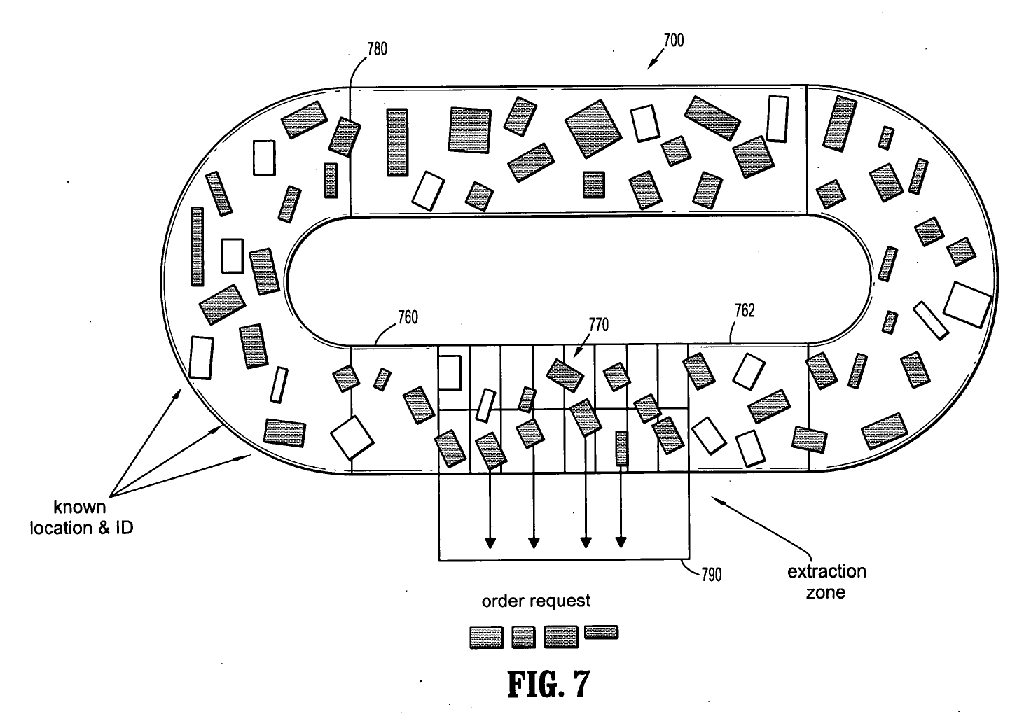

As shown in FIG. 7, another exemplary embodiment manipulation system (MS) is indicated generally by the reference numeral 700. The embodiment 700 of FIG. 7 is nicknamed “Lazy River” due to its resemblance to a popular water park ride. Here, the LM 770 is skirted by two optional MAs 760 and 762 such as in above-mentioned embodiments, and a carousel-shaped loop 780 with optional bidirectional speed control. Items are released onto the carousel belt in flow from one or more intake locations. One ore more LM 770 portions may be used to produce sorted, in-order, singulated, selective, or palletized delivery, as needed by the application.

Thus, the platform of the system 700 in its “Lazy River” configuration has one or more cross-belt sorters surrounded by a carousel-like conveyor loop. Parcels are inducted in bulk into loop from one or more locations. In the example shown, items are removed from the flow that fulfill and/or consolidate a requested mixed-item order.

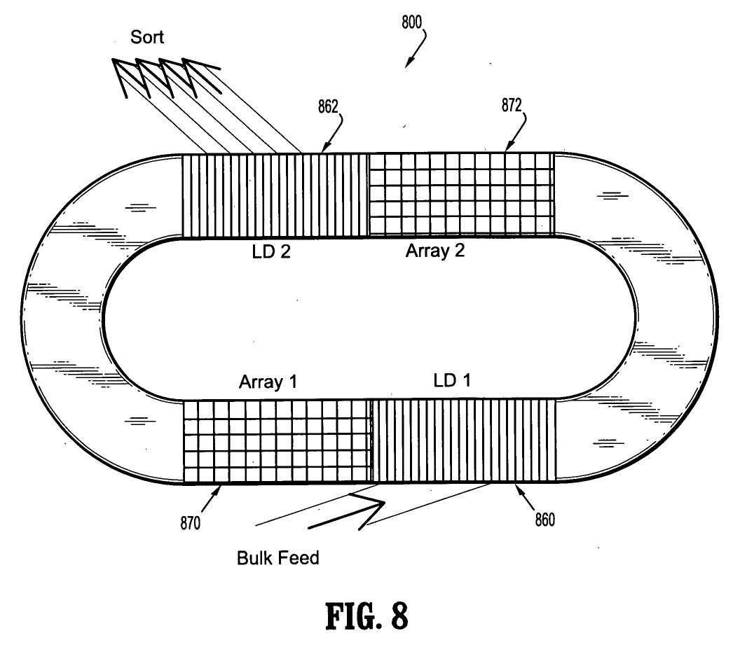

Turning to FIG. 8, a first possible scheme for product induct and takeaway in a Lazy River device is indicated generally by the reference numeral 800. The MS 800 includes a first array 870, a second array 872, a first lateral displacer (LD) 860, and a second LD 862. Here, both induct and takeaway connect from the outside of the device.

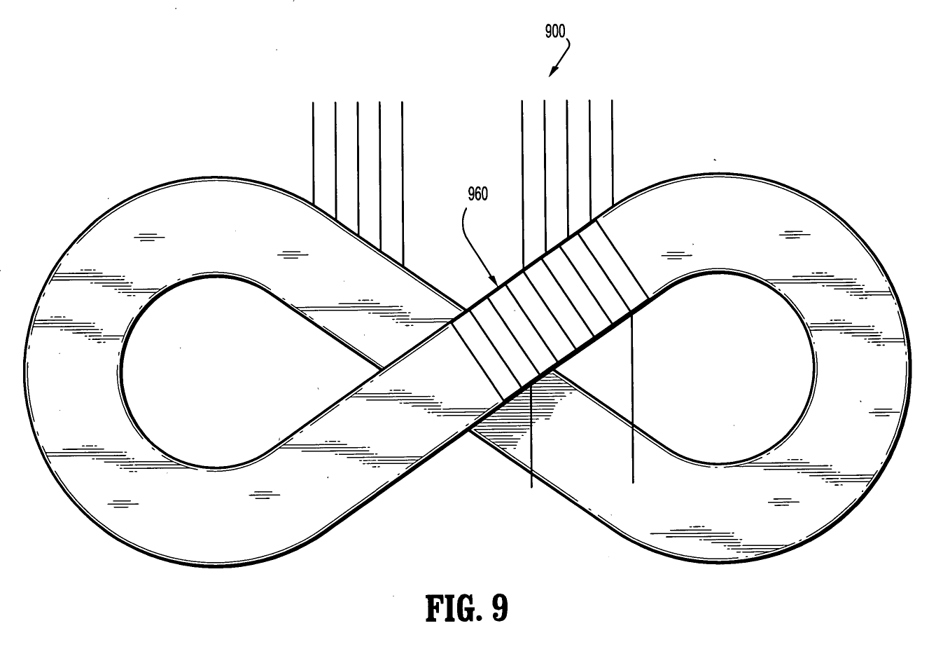

Turning now to FIG. 9, a second possible scheme for product induct and takeaway in a Lazy River device is indicated generally by the reference numeral 900. The MS 900 includes a LD 960, and is similar to the MS 800 of FIG. 8, but distorts the Lazy River oval onto a figure-8-shaped conveyor, so that incoming and outgoing product flow at opposite sides of the stream, thereby minimizing potential item collisions.

Thus, the MS 900 is one possible configuration for the induct and takeaway portions of Lazy River, where, in the induct, the bulk feed is presented at a forward-moving cross-belt conveyor which follows a manipulation array. For the takeaway, product is delivered to specific sortation lanes by a cross-belt conveyor following a second manipulation array. That is, the Lazy River induct and takeaway arrangement can be balanced to enter and leave at opposite sides of the stream with a figure-8-shaped conveyor.

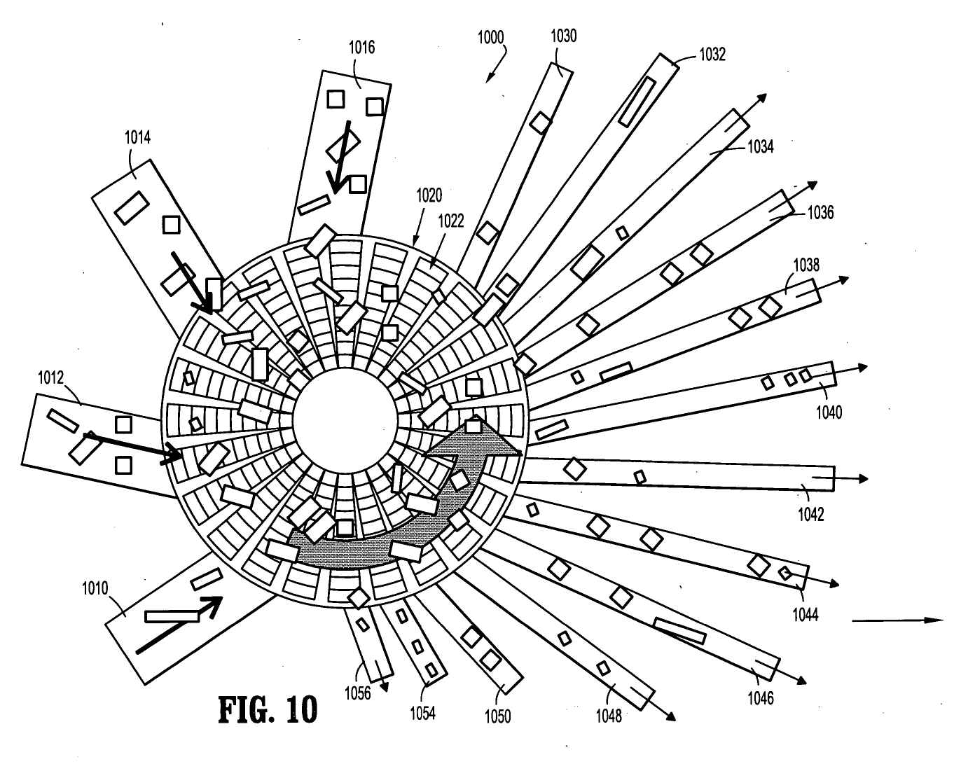

As shown in FIG. 10, a variant of the Lazy River design is indicated generally by the reference numeral 1000. The variant 1000 is dubbed the “Nautilus”, with a similar configuration of inducts and takeaways to those of the MS 800 of FIG. 8, except that the manipulation mechanics is rotating and distributed as an array of radially-arranged cross-belt conveyors. The MS 1000 or Nautilus includes input bulk conveyors 1010, 1012, 1014 and 1016, each connected to the outside of a polar array 1020. The polar array 1020 includes a plurality of radially arranged belt arrays 1022. The polar array 1020 produces the required lineal displacements between parcels so they can be extracted. The polar array 1020, in turn, is connected to extraction zones 1030, 1032, 1034, 1036, 1038, 1040, 1042, 1044, 1046, 1048, 1050, 1052, 1054 and 1056.

Thus, the Nautilus shown is a variant of the Lazy River concept where the manipulation kinematics includes a rotating magazine or radial array 1020 of radially arranged belt arrays 1022 that can selectively absorb bulk-inducted product from the input bulk conveyors on the left and deliver them opportunistically to the takeaways or extraction zones on the right.

In exemplary embodiments, a manipulation platform for packages combines item identification with sortation. These operations occur simultaneously on the same manipulation area. Identification and sortation are performed while the packages are still in bulk or unsingulated. The system includes an input conveyor, a manipulation bed containing a plurality of actuators such as conveyor belts, one or more lateral motion devices disposed relative to the input conveyor, and one or more extraction zones disposed relative to the lateral motion device. A related method includes receiving bulk items, identifying the bulk items, conveying the bulk items, tracking the bulk items, and sorting the bulk items while they are still in bulk, by selectively manipulating them under algorithmic control.

Embodiments of the present disclosure may be particularly advantageous for application to reduced-footprint sortation systems for which real-estate usage is a high priority. Thus, the carousel technology can be used in reduced-footprint processing of returns of retail items, for example. After items are returned, they are placed over the carousel, possibly retagged, and reorganized into homogeneous groups. Variants of the above and other embodiments can also be used in the processing of beverage container returns, such as bottle returns that pay back the returner as an incentive. Bottles can be identified by shape or color or special markings, and be separated purposefully based on manufacturer, crate, or the like prior to washing and refilling.

In alternate embodiments of the apparatus 100, some or all of the computer program code may be stored in registers located on the processor chip 102. In addition, various alternate configurations and implementations of the 2D to 3D vessel based registration unit 180 may be made, as well as of the other elements of the system 100.

It is to be understood that the teachings of the present disclosure may be implemented in various forms of hardware, software, firmware, special purpose processors, or combinations thereof. Most preferably, the teachings of the present disclosure are implemented as a combination of hardware and software.

Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (CPU), a random access memory (RAM), and input/output (I/O) interfaces.

The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as additional imaging units, data storage units and/or printing units.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A sortation platform with in-bulk package identification and continuous tracking of items, comprising:
an input conveyor;
a manipulation platform having a plurality of individual actuators;
at least one lateral motion device disposed relative to the input conveyor and embedded into the manipulation platform; and
at least one extraction zone disposed relative to the lateral motion device.

2. A sortation system as defined in claim 1, further comprising:
an identification unit in signal communication with at least one of the input conveyor or the lateral motion device; and
a tracking unit in signal communication with at least one of the lateral motion device or the extraction zone.

3. A sortation system as defined in claim 1, further comprising an overflow bidirectional conveyor disposed between the lateral motion device and the extraction zone.

4. A sortation system as defined in claim 1, further comprising a bulk conveyor disposed between the input conveyor and the lateral motion device, wherein location, identification, and tracking of items may all occur while the items are still in the bulk conveyor.

5. A sortation system as defined in claim 4 wherein the bulk conveyor is based on a combination of straight or curved conveyors.

6. A sortation system as defined in claim 4, further comprising a manipulation array disposed relative to the lateral motion device.

7. A sortation system as defined in claim 4, further comprising a cross-belt slat conveyor disposed relative to the extraction zone for individual item extraction.

8. A sortation system as defined in claim 1 wherein a fed stream of items comprising parcels, crates, consumer articles, or returns, is spatially manipulated to achieve a specific operation of sortation, separation, order consolidation, palletizing, depalletizing, parallel presentation, rejection, or reordering.

9. A sortation system as defined in claim 1, further comprising a sensor in signal communication with the lateral motion device for distributed manipulation and control of a system for early in-bulk identification of parcels.

10. A sortation system as defined in claim 2 wherein the identification unit is responsive to item shape, color, barcode, or radio frequency identification (RFID) tags.

11. A sortation system as defined in claim 1, the lateral motion device comprising:
at least one cross-conveyor section with principal motion along the bulk flow, each of the at least one section having a plurality of perpendicular or cross belts.

12. A sortation system as defined in claim 11 wherein the cross belts have selective bidirectional speed.

13. A sortation system as defined in claim 1, further comprising:
a first manipulator array disposed upstream relative to the lateral motion device; and
a second manipulator array disposed downstream relative to the lateral motion device.

14. A sortation system as defined in claim 1, further comprising at least one other lateral motion device disposed laterally adjacent to the first lateral motion device and upstream of the extraction zone.

15. A sortation system as defined in claim 1 disposed in the shape of a ring or oval.

16. A sortation system as defined in claim 15, further comprising at least one manipulator array disposed upstream of the lateral motion device.

17. A sortation system as defined in claim 1 disposed in the shape of a figure eight.

18. A sortation system as defined in claim 1 disposed in the shape of a lazy river.

19. A sortation system as defined in claim 1 disposed in the shape of a nautilus.

20. A sortation system as defined in claim 1 wherein the lateral motion device forms a ring having a plurality of radially arranged belt arrays.

21. A sortation method for in-bulk identification and continuous tracking of items, the method comprising:
receiving bulk items;
identifying the bulk items;
conveying the bulk items;
tracking the bulk items; and
sorting the bulk items while they are still in bulk.

22. A sortation method as defined in claim 21, further comprising extracting the sorted bulk items.

23. A system for sortation using in-bulk identification and continuous tracking of items, comprising:
a controller;
an identification unit in signal communication with the controller for identifying the items during bulk conveyance; and
a control unit in signal communication with the controller for tracking the items during bulk conveyance.

24. A program storage device readable by machine, tangibly embodying a program of instructions executable by the machine to perform program steps for sortation using in-bulk identification and continuous tracking of items, the program steps comprising:
receiving bulk items;
identifying the bulk items;
conveying the bulk items;
tracking the bulk items; and
sorting the bulk items while they are still in bulk.
